(19) United States
(12) Patent Application Publication
(10) Pub. No.: US 2026/0116090 A1
(43) Pub. Date: Apr. 30, 2026

(54) DRYING DEVICE AND RECORDING DEVICE

(71) Applicant: SEIKO EPSON CORPORATION, Tokyo (JP)

(72) Inventor: Tadashi AIZAWA, Matsumoto-shi (JP)

(21) Appl. No.: 19/366,901

(22) Filed: Oct. 23, 2025

(30) Foreign Application Priority Data
Oct. 25, 2024 (JP) 2024-188053

(51) Int. Cl. B41J 11/00

(52) U.S. Cl. CPC B41J 11/00218; B41J 11/00212; B41J 11/00216

(57) ABSTRACT

Each of a plurality of electromagnetic wave generation sections dries a medium onto which liquid was ejected by generating an electromagnetic wave in response to application of a high-frequency voltage. Each of the plurality of electromagnetic wave generation sections includes a first electrode, a second electrode arranged so as to surround the first electrode in plan view from a first direction toward the medium, a first conductor that includes a coil and that electrically connects a transmission line, which is configured to transmit a high-frequency voltage, and the first electrode, and a second conductor that electrically connects the transmission line and the second electrode. The first metal plate is arranged at a position sandwiching the medium with respect to the plurality of electromagnetic wave generation sections in the first direction and between the first electromagnetic wave generation section and the second electromagnetic wave generation section in the second direction, is configured to extend along the first direction. The first metal plate is electrically connected to the second electrode of the first electromagnetic wave generation section and to the second electrode of the second electromagnetic wave generation section.

The present application is based on, and claims priority from JP Application Serial Number 2024-188053, filed October 25, 2024, the disclosure of which is hereby incorporated by reference herein in its entirety.

### BACKGROUND

### 1. Technical Field

The present disclosure relates to a drying device and a recording device.

### 2. Related Art

For example, as in JP-A-2022-39286, a liquid ejection device including a drying device that dries a medium onto which liquid was ejected is disclosed. In order to improve drying efficiency, such a drying device includes a plurality of alternating current electric field generation sections that dry a medium by generating electromagnetic waves with respect to the medium onto which liquid was ejected. Such an alternating current electric field generation section is an example of an electromagnetic wave generation section, and generates an electromagnetic wave for a medium by supplying a high-frequency voltage between a first electrode and a second electrode. By this, the medium onto which liquid was ejected can be dried.

However, in such a drying device, when a plurality of electromagnetic wave generation sections are arranged, the plurality of electromagnetic wave generation sections need to be separated from each other so as not to be interfered with by an alternating current electric field. This may lead to an increase in the size of the drying device.

### SUMMARY

A drying device to overcome the above-described problem includes a plurality of electromagnetic wave generation sections that dry a medium, onto which liquid was ejected, by generating an electromagnetic wave in response to application of a high-frequency voltage and a first metal plate, wherein each of the plurality of electromagnetic wave generation sections includes a first electrode, a second electrode arranged so as to surround the first electrode in plan view from a first direction toward the medium, a first conductor that includes a coil and that electrically connects a transmission line, which is configured to transmit a high-frequency voltage, and the first electrode, and a second conductor that electrically connects the transmission line and the second electrode, the plurality of electromagnetic wave generation sections include a first electromagnetic wave generation section and a second electromagnetic wave generation section, the first electromagnetic wave generation section and the second electromagnetic wave generation section are arranged side by side in a second direction that intersects the first direction, and the first metal plate is arranged at a position sandwiching the medium with respect to the plurality of electromagnetic wave generation sections in the first direction and between the first electromagnetic wave generation section and the second electromagnetic wave generation section in the second direction, is configured to extend along the first direction, and is electrically connected to the second electrode of the first electromagnetic wave generation section and to the second electrode of the second electromagnetic wave generation section.

A recording device to overcome the above-described problem includes a recording section that performs recording by ejecting liquid onto a medium; a plurality of electromagnetic wave generation sections that dry the medium onto which liquid was ejected by the recording section by generating an electromagnetic wave in response to application of a high-frequency voltage; and a first metal plate, wherein each of the plurality of electromagnetic wave generation sections includes a first electrode, a second electrode arranged so as to surround the first electrode in plan view from a first direction toward the medium, a first conductor that includes a coil and that electrically connects a transmission line, which is configured to transmit a high-frequency voltage, and the first electrode, and a second conductor that electrically connects the transmission line and the second electrode, the plurality of electromagnetic wave generation sections include a first electromagnetic wave generation section and a second electromagnetic wave generation section, the first electromagnetic wave generation section and the second electromagnetic wave generation section are arranged side by side in a second direction that intersects the first direction, and the first metal plate is arranged at a position sandwiching the medium with respect to the plurality of electromagnetic wave generation sections in the first direction and between the first electromagnetic wave generation section and the second electromagnetic wave generation section in the second direction, is configured to extend along the first direction, and is electrically connected to the second electrode of the first electromagnetic wave generation section and to the second electrode of the second electromagnetic wave generation section.

### BRIEF DESCRIPTION OF THE DRAWINGS

FIG. 1 is a schematic diagram showing a recording system of a first embodiment.

FIG. 2 is a perspective view showing a drying unit of the first embodiment.

FIG. 3 is a schematic diagram showing the drying unit of the first embodiment.

FIG. 4 is a schematic diagram showing the drying unit of the first embodiment.

FIG. 5 is a schematic diagram showing the drying unit of the first embodiment.

FIG. 6 is a schematic diagram showing a drying unit of a modification.

### DESCRIPTION OF EMBODIMENTS

### FIRST EMBODIMENT

Hereinafter, an embodiment of a recording system including a drying device and a recording device will be described. In the following description, a direction intersecting a vertical direction Z is referred to as a width direction X, and a direction intersecting the vertical direction Z and the width direction X is referred to as an intersecting direction Y. One direction along the width direction X is referred to as a first width direction X1, and the other direction along the width direction X is referred to as a second width direction X2. One direction along the intersecting direction Y is referred to as a first intersecting direction Y1, and the other direction along the intersecting direction Y is referred to as a second intersecting direction Y2. In the vertical direction Z, an upper direction is referred to as an upper direction Z1, and a lower direction is referred to as a lower direction Z2. The lower direction Z2 corresponds to an example of a first direction. The width direction X corresponds to an example of a second direction. The intersecting direction Y corresponds to an example of a third direction. The first intersecting direction Y1 corresponds to an example of one side of the third direction, and the second intersecting direction Y2 corresponds to an example of the other side of the third direction. Plan view from the upper direction Z1 is simply referred to as top view. Plan view from the second width direction X2 is simply referred to as front view.

### Configuration of recording system 10

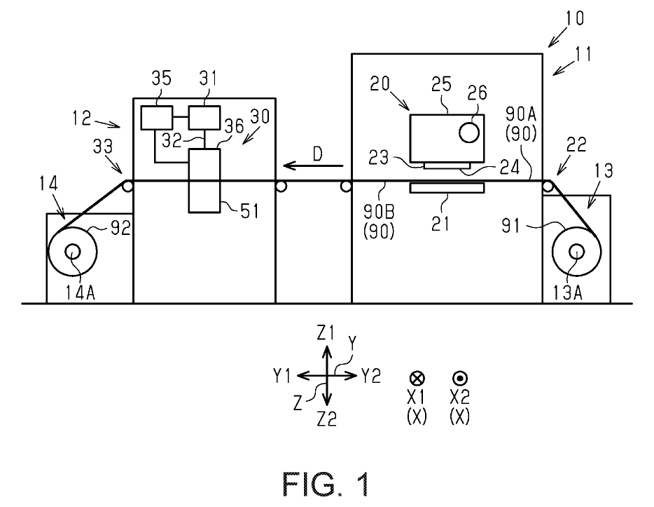

As shown in FIG. 1, a recording system 10 is a system that performs recording on a medium 90. In particular, the recording system 10 is a system that performs recording on the medium 90 by ejecting liquid onto the medium 90. The recording system 10 is a system that dries the medium 90 after recording onto which liquid was ejected.

The recording system 10 includes a recording device 11. The recording device 11 is configured to perform recording on the medium 90. In particular, the recording device 11 performs recording on the medium 90 by ejecting liquid onto the medium 90. The recording device 11 may be an inkjet type printer that performs recording by ejecting ink, which is an example of liquid, onto the medium 90. The medium 90 includes a front surface 90A and a back surface 90B. The medium 90 is fabric, but may be, for example, paper.

The recording system 10 includes a drying device 12. The drying device 12 is configured to dry the medium 90 after recording onto which the recording device 11 ejected liquid. In particular, the drying device 12 dries the medium 90 after recording by generating electromagnetic waves.

The recording system 10 includes a feeding section 13. The feeding section 13 feeds the medium 90 before recording to the recording device 11. The feeding section 13 includes a feed roller 13A. The feed roller 13A extends along the width direction X. In the width direction X, the width of the feed roller 13A is longer than the width of the medium 90. The feed roller 13A is configured to rotatably hold a first roll body 91. The first roll body 91 is the medium 90 before recording that is wound and stacked. The medium 90 may be elongated. In this way, the feed roller 13A holds the medium 90 to be fed to the recording device 11.

The recording system 10 includes a winding section 14. The winding section 14 winds up the medium 90 after recording by the recording device 11. In particular, the winding section 14 winds up the medium 90 after recording and drying by the drying device 12. The winding section 14 includes a winding roller 14A. The winding roller 14A extends along the width direction X. In the width direction X, the width of the winding roller 14A is longer than the width of the medium 90. The winding roller 14A is configured to rotatably hold a second roll body 92. The second roll body 92 is the medium 90 after recording that is wound and stacked. In this way, the winding roller 14A winds up the medium 90 that was recorded by the recording device 11 and dried by the drying device 12.

### Configuration of recording device 11

Here, a configuration of the recording device 11 will be described in detail.

The recording device 11 includes a recording section 20, a recording support section 21, and a recording transport section 22. The recording section 20 is configured to perform recording on the medium 90 by ejecting liquid onto the medium 90. The recording section 20 is configured to perform recording on the medium 90 by ejecting liquid onto the front surface 90A of the medium 90. The recording section 20 performs recording on the medium 90 supported by the recording support section 21. The recording section 20 performs recording on the medium 90 transported by the recording transport section 22.

The recording section 20 includes a head 23. The head 23 may be a serial head or may be a line head. A serial head is a head that scans in the width direction X of the medium 90. A line head is a head that records simultaneously across the width direction X of the medium 90.

The head 23 includes a nozzle surface 24 in which nozzles (not shown) are opened. The nozzle surface 24 is a surface facing the lower direction Z2. The nozzle surface 24 is a surface facing the front surface 90A of the medium 90 transported by the recording transport section 22. Each of the plurality of nozzles is configured to open up in the lower direction Z2. Each of the plurality of nozzles is configured to eject liquid.

The recording section 20 may include a carriage 25 and a carriage support section 26. The carriage 25 is configured to support the head 23. The carriage support section 26 extends along the width direction X. The carriage support section 26 supports the carriage 25 so as to be movable along the width direction X. The carriage 25 is movable in the width direction X along the carriage support section 26 by a driving force from a drive source (not shown).

The recording support section 21 is configured to support the medium 90 transported by the recording transport section 22. The recording support section 21 is positioned in the lower direction Z2 of the recording section 20. The recording support section 21 supports the back surface 90B of the medium 90 transported by the recording transport section 22. The recording support section 21 is positioned in the lower direction Z2 of the head 23.

The recording transport section 22 is configured to transport the medium 90 in a transport direction D. The transport direction D is a direction along the intersecting direction Y. The recording transport section 22 may include a plurality of rollers. Although the recording transport section 22 transports the medium 90 in the transport direction D using the plurality of rollers, the recording transport section 22 may transport the medium 90 in the transport direction D using a transport belt driven by a plurality of rollers. The recording transport section 22 may perform intermittent transport in which the transport and stop of the medium 90 are repeated.

### Configuration of drying device 12

Next, a configuration of the drying device 12 will be described in detail.

The drying device 12 includes a drying unit 30. The drying unit 30 is configured to dry the medium 90 after recording. That is, the drying device 12 sets the medium 90 on which recording was performed by the recording section 20 as a target to be dried.

The drying unit 30 is configured to dry the medium 90 after recording by generation of electromagnetic waves. The drying unit 30 is positioned both in the upper direction Z1 and in the lower direction Z2 of the medium 90.

The drying device 12 includes a high-frequency voltage generation section 31. The drying device 12 may include a plurality of high-frequency voltage generation sections 31. The high-frequency voltage generation section 31 is configured to generate a high-frequency voltage. The high-frequency voltage generation section 31 supplies a high-frequency voltage to the drying unit 30 through a transmission line 32.

The plurality of high-frequency voltage generation sections 31 may supply a high-frequency voltage to a plurality of electromagnetic wave generation sections 36 (to be described later) independently of each other. That is, one high-frequency voltage generation section 31 may be connected to one electromagnetic wave generation section 36 so as to form a pair.

The transmission line 32 is a line for connecting the drying unit 30 and the high-frequency voltage generation section 31. The transmission line 32 is capable of transmitting a high-frequency voltage from the high-frequency voltage generation section 31 to the drying unit 30. That is, the transmission line 32 is capable of transmitting a high-frequency voltage.

The transmission line 32 may be a coaxial cable, but is not limited to coaxial cable. The transmission line 32 may include a first line and a second line. The first line may be a core line of the transmission line 32. The second line may be an electromagnetic shield that covers the first line.

The drying device 12 includes a drying transport section 33. The drying transport section 33 is configured to transport the medium 90 in the transport direction D. The transport direction D is a direction along the intersecting direction Y. The drying transport section 33 may transport the medium 90 in the transport direction D using a plurality of rollers. The drying transport section 33 may perform continuous transport in which the medium 90 is continuously transported. Slackening of the medium 90 may occur between the recording transport section 22 and the drying transport section 33.

The drying device 12 includes a control section 35. The control section 35 controls the drying device 12. Specifically, the control section 35 controls the drying unit 30. The control section 35 controls the high-frequency voltage generation section 31. The control section 35 controls the drying transport section 33.

The control section 35 may be constituted by one or more processors that execute various processes in accordance with a computer program. The control section 35 may be composed of one or more dedicated hardware circuits. The control section 35 may be configured with an application specific integrated circuit that executes at least a part of various processes. The control section 35 may be composed of a processor and a circuit including a combination of hardware circuits. The processor includes a CPU and memories such as a RAM and a ROM. The memory stores program codes or commands configured to cause the CPU to perform processes. Memory, that is computer-readable medium, includes any readable medium that can be accessed by a general-purpose or dedicated computer.

The drying unit 30 includes an electromagnetic wave generation section 36. The electromagnetic wave generation section 36 is configured to generate an electromagnetic wave in response to application of a high-frequency voltage. The electromagnetic wave generation section 36 generates an electromagnetic wave in response to application of a high-frequency voltage. By this, the electromagnetic wave generation section 36 is configured to dry the medium 90 onto which liquid was ejected by the recording section 20. The electromagnetic wave generation section 36 is positioned in the upper direction Z1 of the medium 90, but is not limited thereto.

The electromagnetic wave generation section 36 generates an alternating current electric field by generating an electromagnetic wave. An electromagnetic wave generated by the electromagnetic wave generation section 36 has an electric field as a main component. The electromagnetic wave generation section 36 can significantly reduce induction of a magnetic field due to a generated electric field as compared with an electromagnetic wave generation section that generates a normal electromagnetic wave.

As a specific example, the electromagnetic wave generation section 36 generates electromagnetic waves of 2.4 GHz, but is not limited to this. The electromagnetic wave generation section 36 may generate, for example, electromagnetic waves of 3 MHz to 300 MHz. The electromagnetic wave generation section 36, for example, may generate electromagnetic waves of 300 MHz to 30 GHz, and among these, may generate electromagnetic waves of 10 MHz to 20 GHz.

The electromagnetic wave generation section 36 dries the medium 90 by heating the medium 90 from the front surface 90A. Specifically, the electromagnetic wave generation section 36 heats liquid ejected onto the medium 90 from the front surface 90A. The electromagnetic wave generation section 36 dries the medium 90 by vaporizing liquid ejected onto the medium 90. That is, the electromagnetic wave generation section 36 is a method of drying the medium 90 regardless of whether or not water vapor is saturated around the medium 90. Therefore, the electromagnetic wave generation section 36 does not need to blow dry gas that is not saturated with water vapor around the medium 90.

### Arrangement of electromagnetic wave generation sections 36

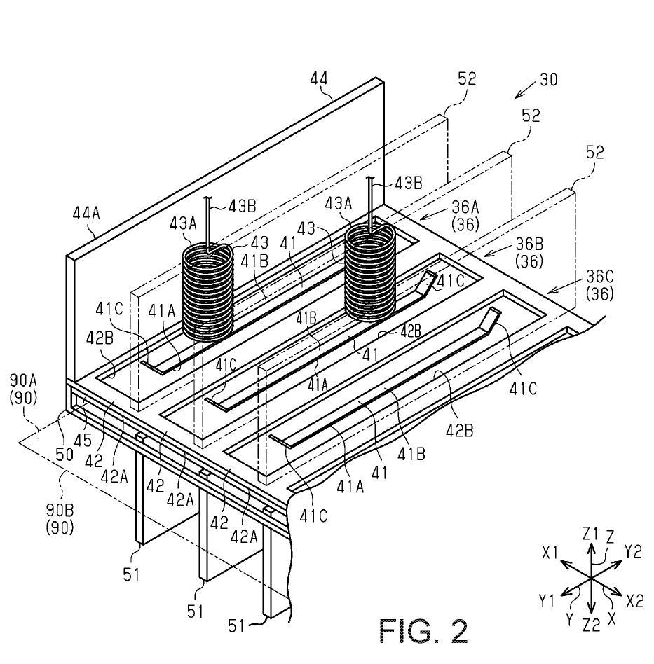

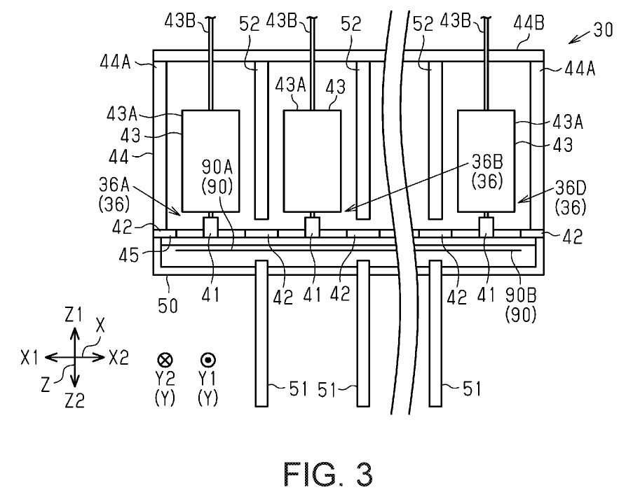

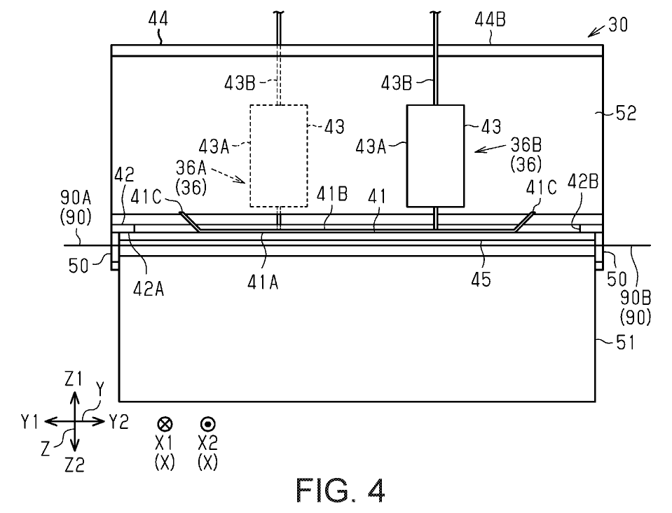

As shown in FIG. 2, the drying unit 30 includes a plurality of electromagnetic wave generation sections 36. That is, the drying device 12 includes a plurality of electromagnetic wave generation sections 36. The plurality of electromagnetic wave generation sections 36 include a first electromagnetic wave generation section 36A and a second electromagnetic wave generation section 36B. The plurality of electromagnetic wave generation sections 36 may include a third electromagnetic wave generation section 36C. The plurality of electromagnetic wave generation sections 36 may include a fourth electromagnetic wave generation section 36D shown in FIGS. 3 and 4.

The plurality of electromagnetic wave generation sections 36 are arranged side by side in the width direction X. That is, the first electromagnetic wave generation section 36A and the second electromagnetic wave generation section 36B are arranged side by side in the width direction X.

### Configuration of electromagnetic wave generation section 36

The electromagnetic wave generation section 36 includes a first electrode 41, a second electrode 42, a first conductor 43, and a second conductor 44. The electromagnetic wave generation section 36 may include a facing section 45. FIG. 2 is a diagram in which the first electrode 41 and the second electrode 42 are arranged on an upper direction Z1 side of the medium 90.

The first electrode 41 has a flat plate shape, but may have a rod shape. The first electrode 41 is elongated in the intersecting direction Y in plan view. That is, the first electrode 41 extends in the intersecting direction Y in plan view. The first electrode 41 may have a rectangular shape in plan view.

The first electrode 41 includes a first electrode surface 41A. The first electrode surface 41A is a surface facing the lower direction Z2. That is, the first electrode surface 41A is a surface facing the front surface 90A of the medium 90. The first electrode 41 is arranged such that the first electrode surface 41A is in contact with the facing section 45.

The first electrode 41 includes a central section 41B and both end sections 41C. The central section 41B is a section positioned at the center in the intersecting direction Y. The both end sections 41C are sections positioned at both ends in the intersecting direction Y. The central section 41B and the both end sections 41C are provided integrally.

The central section 41B constitutes the first electrode surface 41A. The central section 41B is provided at a position overlapping with the second electrode 42 in the vertical direction Z. That is, at least a part of the first electrode 41 is provided at a position overlapping with the second electrode 42 in the vertical direction Z.

The both end sections 41C are configured to be upwardly inclined with respect to the outside in the intersecting direction Y. The both end sections 41C are positioned away from the facing section 45. That is, the both end sections 41C extend in the upper direction Z1 away from the medium 90 in the vertical direction Z. The both end sections 41C may be curved away from the facing section 45.

The second electrode 42 has a flat plate shape. The second electrode 42 includes a second electrode surface 42A. The second electrode surface 42A is a surface facing the lower direction Z2. That is, the second electrode surface 42A is a surface facing the front surface 90A of the medium 90. The second electrode 42 is arranged such that the second electrode surface 42A is in contact with the facing section 45.

The second electrode 42 includes an opening section 42B. The opening section 42B has a rectangular shape in plan view, but may have a rectangular shape with rounded corners. The first electrode 41 is positioned in the opening section 42B in plan view. The opening section 42B surrounds the first electrode 41 in plan view. That is, the second electrode 42 is arranged so as to surround the first electrode 41 in plan view.

the second electrodes 42 in the plurality of electromagnetic wave generation sections 36 may be shared at positions adjacent to each other in the width direction X. Specifically, the second electrode 42 in the second width direction X2 of the first electromagnetic wave generation section 36A and the second electrode 42 in the first width direction X1 of the second electromagnetic wave generation section 36B are shared. That is, the second electrode 42 of the first electromagnetic wave generation section 36A and the second electrode 42 of the second electromagnetic wave generation section 36B are shared at a position where the first electromagnetic wave generation section 36A and the second electromagnetic wave generation section 36B are arranged side by side in the width direction X.

The first conductor 43 is configured to electrically connect the transmission line 32 and the first electrode 41. The first conductor 43 includes a coil 43A. The coil 43A extends in the vertical direction Z. One end of the coil 43A is connected to the first electrode 41. The other end of the coil 43A is connected to a conductor wire 43B.

Specifically, in the first electromagnetic wave generation section 36A, the first conductor 43 is connected to the first electrode 41 at a position in the first intersecting direction Y1 away from the center in the intersecting direction Y. That is, the coil 43A of the first electromagnetic wave generation section 36A is arranged on a first intersecting direction Y1 side in front view.

In the second electromagnetic wave generation section 36B, the first conductor 43 is connected to the first electrode 41 at a position in the second intersecting direction Y2 away from the center in the intersecting direction Y. That is, the coil 43A of the second electromagnetic wave generation section 36B is arranged on a second intersecting direction Y2 side in front view.

In this way, the coil 43A of the first electromagnetic wave generation section 36A and the coil 43A of the second electromagnetic wave generation section 36B are arranged at positions that do not overlap each other in front view. This makes it possible to reduce the influence of a strong magnetic field between the coil 43A in the first electromagnetic wave generation section 36A and the coil 43A in the second electromagnetic wave generation section 36B adjacent to each other in the width direction X. In FIG. 2, for easy understanding of the disclosure, the first conductors 43 in the first electromagnetic wave generation section 36A and the second electromagnetic wave generation section 36B are shown, and the first conductors 43 in the other electromagnetic wave generation sections 36 are omitted.

As shown in FIGS. 3 and 4, the second conductor 44 is configured to electrically connect the transmission line 32 and the second electrode 42. The second conductor 44 may include a columnar support 44A. The second conductor 44 may include a plurality of columnar supports 44A. The columnar supports 44A are electrically connected to the second electrode 42. The columnar support 44A extends from the second electrode 42 in the upper direction Z1. The columnar support 44A is made of metal.

In the present embodiment, the second conductor 44 may include two columnar supports 44A in the width direction X. One second conductor 44 extends in the upper direction Z1 from the second electrode 42 on a first width direction X1 side of the first electromagnetic wave generation section 36A that is arranged closest to a first width direction X1 side. One second conductor 44 extends in the upper direction Z1 from the second electrode 42 on a second width direction X2 side of the fourth electromagnetic wave generation section 36D that is arranged closest to a second width direction X2 side.

The second conductor 44 may include a top plate 44B. The top plate 44B is electrically connected to the columnar supports 44A. The top plate 44B is provided at an upper end section of the columnar supports 44A. The top plate 44B connects a plurality of the columnar supports 44A. The top plate 44B may be integrated with the columnar support 44A. The top plate 44B is made of metal. In FIG. 2, the top plate 44B is omitted for easy understanding of the disclosure.

As shown in FIG. 2, the facing section 45 is positioned in the lower direction Z2 of the first electrode 41 and the second electrode 42. That is, the facing section 45 is positioned between the first electrode 41 and the second electrode 42, and the medium 90. The facing section 45 may have a flat plate shape.

The facing section 45 is made of a material that transmits the electromagnetic waves generated by the electromagnetic wave generation section 36. The facing section 45 is arranged so as to face the front surface 90A of the medium 90. The facing section 45 may not be in contact with the medium 90, and may be in contact with the medium 90. The facing section 45 protects the first electrode 41 and the second electrode 42. The facing section 45 is composed of a member having insulating properties. The facing section 45 may be a glass plate. The facing section 45 may be a ceramic with high transmittance. The facing section 45 may be made of a resin with a low dissipation factor. The facing section 45 may be made of polypropylene. The facing section 45 may be made of polyethylene.

With the electromagnetic wave generation section 36 configured as described above, when a high-frequency voltage is applied, the first electrode 41 and the second electrode 42 generate electromagnetic waves in response to application of a high-frequency voltage, thereby heating the medium 90.

Such an electromagnetic wave generation section 36 can transmit a large amount of thermal energy to the medium 90 due to generation of electromagnetic waves. The electromagnetic wave generation section 36 is not of a thermal conduction type but of an electromagnetic wave type, and does not need to include a member such as a heating wire for heating. This allows the electromagnetic wave generation section 36 to be made smaller in size.

The minimum separation distance between the first electrode 41 and the second electrode 42 is equal to or less than 1/10 of the wavelength of an electromagnetic wave output from the electromagnetic wave generation section 36. By this, electromagnetic waves generated when a high-frequency voltage is applied can be attenuated in the vicinity of the first electrode 41 and the second electrode 42. By this, it is possible to reduce the intensity of an electromagnetic wave that reaches a distant place from the first electrode 41 and the second electrode 42. That is, an electromagnetic wave generated from the electromagnetic wave generation section 36 is very strong in the vicinity of the first electrode 41 and the second electrode 42, and is very weak in a distant place.

Such an electromagnetic wave generation section 36 can intensively generate an alternating current electric field in the vicinity of the first electrode 41 and the second electrode 42 by appropriately controlling the frequency band of an electromagnetic wave to be generated. In other words, it is possible to suppress the influence on the surroundings accompanying the generation of electromagnetic waves beyond the vicinity of the first electrode 41 and the second electrode 42. The vicinity of the first electrode 41 and the second electrode 42 may correspond to a range of, for example, 3 mm to 3 cm.

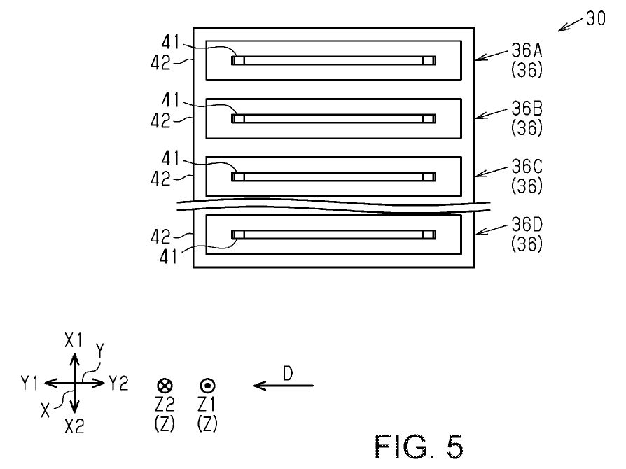

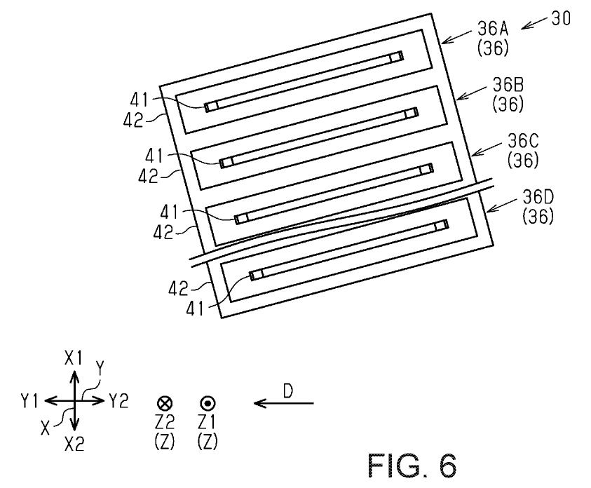

In the present embodiment, as shown in FIG. 5, the drying unit 30 is arranged such that the first electrode 41 extends along the intersecting direction Y for easy understanding of the disclosure, but the present disclosure is not limited thereto. As shown in FIG. 6, the first electrode 41 may be arranged to be inclined at a predetermined angle from the intersecting direction Y. By this, it is possible to promote the uniformity of drying of the medium 90. In such a case, a direction in which the plurality of electromagnetic wave generation sections 36 are arranged is an example of the second direction, and a direction intersecting the vertical direction Z and the second direction is an example of the third direction.

### Each metal plate 51,52

As shown in FIGS. 2 to 4, the drying unit 30 includes a connection section 50, a first metal plate 51, and a second metal plate 52. That is, the drying device 12 includes the connection section 50, the first metal plate 51, and the second metal plate 52. The drying unit 30 may include a plurality of connection sections 50, a plurality of first metal plates 51, and a plurality of second metal plates 52. In FIG. 2, the second metal plates 52 is indicated by two dot chain lines for easy understanding of the disclosure.

The first metal plates 51 are provided at positions where the medium 90 is sandwiched between the first metal plate 51 and the plurality of electromagnetic wave generation sections 36 in the vertical direction Z. The first metal plate 51 may have a flat plate shape. The first metal plate 51 is configured to extend along the vertical direction Z. The first metal plate 51 is provided between the plurality of electromagnetic wave generation sections 36 adjacent to each other. Specifically, the first metal plate 51 is provided between the first electromagnetic wave generation section 36A and the second electromagnetic wave generation section 36B in the width direction X.

The connection section 50 has conductivity. The connection section 50 has a flat plate shape, but may have a linear shape. The connection section 50 is configured to electrically connect the plurality of first metal plates 51 and the second electrode 42.

The connection section 50 is electrically connected to the plurality of first metal plates 51 at both end sections of an end section in the first intersecting direction Y1 and an end section in the second intersecting direction Y2. The connection section 50 is connected to the second electrode 42 at both end sections of an end section in the first intersecting direction Y1 and an end section in the second intersecting direction Y2. The connection section 50 is connected to the second electrode 42 on a first width direction X1 side of the first electromagnetic wave generation section 36A and to the second electrode 42 on a second width direction X2 side of the fourth electromagnetic wave generation section 36D.

In this manner, the first metal plate 51 is electrically connected to the second electrode 42 via the connection section 50. That is, the first metal plate 51 is electrically connected to the second electrode 42 of the first electromagnetic wave generation section 36A and the second electrode 42 of the second electromagnetic wave generation section 36B via the connection section 50. The first metal plate 51 and the second electrode 42 are electrically connected to each other at both end sections in front view via the connection section 50.

The second electrode 42 includes a predetermined region. The predetermined region is a region close to a region of the first electrode 41 to which the coil 43A is connected. When electromagnetic waves are generated from the electromagnetic wave generation section 36, a large electric current flows in the predetermined region of the second electrode 42. Specifically, a large electric current flows from the predetermined region of the second electrode 42 toward both an end section in the first intersecting direction Y1 and an end section in the second intersecting direction Y2. Thus, a strong electric field is generated by a large electric current flowing in the predetermined region of the second electrode 42.

In such a case, the first metal plate 51 is provided so as to attenuate a strong electric field generated in each of the plurality of electromagnetic wave generation sections 36 adjacent to each other in the width direction X. Specifically, the first metal plate 51 can reduce the influence of a strong electric field between the first electromagnetic wave generation section 36A and the second electromagnetic wave generation section 36B adjacent to each other in the width direction X.

In particular, when the first metal plate 51 and the second electrode 42 are electrically connected at both end sections in front view, an electric current flows from both end sections of the second electrode 42 toward the center. That is, an electric current flows from both end sections of the second electrode 42 toward the predetermined region. In this manner, by reducing an electric current value in the predetermined region of the second electrode 42, it is possible to reduce the influence of a strong electric field in the first electromagnetic wave generation section 36A and the second electromagnetic wave generation section 36B.

The first metal plate 51 is provided so as to attenuate the wraparound of a strong magnetic field from the coil 43A in each of the plurality of electromagnetic wave generation sections 36 Specifically, the first metal plate 51 can reduce the influence of a strong magnetic field between the coil 43A of the first electromagnetic wave generation section 36A and the coil 43A of the second electromagnetic wave generation section 36B adjacent to each other in the width direction X.

The second metal plate 52 is provided at a position where the medium 90 is sandwiched between the first metal plate 51 and the second metal plate 52 in the vertical direction Z. The second metal plate 52 may have a flat plate shape. The second metal plate 52 is configured to extend along the vertical direction Z. The second metal plate 52 is provided between the plurality of electromagnetic wave generation sections 36 adjacent to each other. Specifically, the second metal plate 52 is provided between the first electromagnetic wave generation section 36A and the second electromagnetic wave generation section 36B in the width direction X.

The second metal plate 52 may be connected to the top plate 44B. The second metal plate 52 is connected to the second electrode 42 via the second conductor 44. That is, the second metal plate 52 is connected to the second electrode 42 via the second conductor 44. The second electrode 42 of the first electromagnetic wave generation section 36A and the second electrode 42 of the second electromagnetic wave generation section 36B are electrically connected.

The second metal plate 52 is separated from the second electrodes 42 of the plurality of electromagnetic wave generation sections 36 in the vertical direction Z. Specifically, the second metal plate 52 is separated from the second electrode 42 of the first electromagnetic wave generation section 36A and the second electrode 42 of the second electromagnetic wave generation section 36B in the vertical direction Z.

By this, the second metal plate 52 is electrically connected to the second electrode 42 and is arranged at a position that does not affect the first electrode 41. That is, the second metal plate 52 is electrically connected to the second electrode 42 to have the same electric potential as the second electrode 42, and is arranged at a position separated from the first electrode 41 so as not to function as the second electrode 42. Therefore, it is possible to suppress a reduction in energy efficiency of electromagnetic waves generated from the plurality of electromagnetic wave generation sections 36. When the second electrode 42 is grounded, the second metal plate 52 is grounded in the same manner as the second electrode 42.

The second metal plate 52 is provided so as to cover the coils 43A of the plurality of electromagnetic wave generation sections 36 in front view. That is, the second metal plate 52 is provided so as to attenuate a strong magnetic field from the coil 43A in each of the plurality of electromagnetic wave generation sections 36 adjacent to each other in the width direction X. Specifically, the second metal plate 52 can reduce the influence of a strong magnetic field between the coil 43A of the first electromagnetic wave generation section 36A and the coil 43A of the second electromagnetic wave generation section 36B adjacent to each other in the width direction X.

### Operations and effects of first embodiment

Operations and effects of the first embodiment will be described.

(1) The first electromagnetic wave generation section 36A and the second electromagnetic wave generation section 36B are arranged side by side in the width direction X. The first metal plate 51 is arranged at a position sandwiching the medium 90 with respect to the plurality of electromagnetic wave generation sections 36 in the vertical direction Z and between the first electromagnetic wave generation section 36A and the second electromagnetic wave generation section 36B in the width direction X. The first metal plate 51 is configured to extend along the vertical direction Z. The second electrode 42 of the first electromagnetic wave generation section 36A and the second electrode 42 of the second electromagnetic wave generation section 36B are electrically connected. According to this configuration, even when the first electromagnetic wave generation section 36A and the second electromagnetic wave generation section 36B are arranged close to each other, the first metal plate 51 can suppress interference of an alternating current electric field between the first electromagnetic wave generation section 36A and the second electromagnetic wave generation section 36B. Therefore, it is possible to suppress an increase in the size of the drying device 12.

(2) The second metal plate 52 is arranged at a position sandwiching the medium 90 with respect to the first metal plate 51 in the vertical direction Z and between the first electromagnetic wave generation section 36A and the second electromagnetic wave generation section 36B in the width direction X. The second metal plate 52 is configured to extend along the vertical direction Z. The second metal plate 52 is electrically connected to the second electrode 42 of the first electromagnetic wave generation section 36A and the second electrode 42 of the second electromagnetic wave generation section 36B. According to this configuration, even when the first electromagnetic wave generation section 36A and the second electromagnetic wave generation section 36B are arranged close to each other, the second metal plate 52 can suppress interference of an alternating current electric field between the first electromagnetic wave generation section 36A and the second electromagnetic wave generation section 36B. Therefore, it is possible to suppress an increase in the size of the drying device 12.

(3) The second metal plate 52 is separated from the second electrode 42 of the first electromagnetic wave generation section 36A and the second electrode 42 of the second electromagnetic wave generation section 36B in the vertical direction Z. According to this configuration, the second metal plate 52 and the second electrodes 42 are electrically connected to each other, and the second metal plate 52 and the second electrodes 42 are separated from each other. Therefore, by arranging the second metal plate 52 so as to reduce the influence on the first electrode 41, it is possible to suppress a reduction in energy efficiency of electromagnetic waves generated from the plurality of electromagnetic wave generation sections 36.

(4) The coil 43A of the first electromagnetic wave generation section 36A and the coil 43A of the second electromagnetic wave generation section 36B are arranged at positions that do not overlap each other in front view. According to this configuration, the coil 43A of the first electromagnetic wave generation section 36A and the coil 43A of the second electromagnetic wave generation section 36B can be separated from each other. By this, even when the first electromagnetic wave generation section 36A and the second electromagnetic wave generation section 36B are arranged at positions close to each other, it is possible to suppress mutual interference between the coil 43A of the first electromagnetic wave generation section 36A and the coil 43A of the second electromagnetic wave generation section 36B. Therefore, it is possible to suppress an increase in the size of the drying device 12.

(5) The first metal plate 51 is electrically connected at both end sections to the second electrode 42 of the first electromagnetic wave generation section 36A and the second electrode 42 of the second electromagnetic wave generation section 36B in front view. According to this configuration, an electric current having a phase opposite to that of an electric current flowing through the second electrode 42 can be generated in a region close to the coil 43A. Therefore, an electric current flowing in the second electrode 42 can be reduced in a region close to the coil 43A. By this, even when the first electromagnetic wave generation section 36A and the second electromagnetic wave generation section 36B are arranged at positions close to each other, the first metal plate 51 can suppress interference of an alternating current electric field between the first electromagnetic wave generation section 36A and the second electromagnetic wave generation section 36B. Therefore, it is possible to suppress an increase in the size of the drying device 12.

(6) The second electrode 42 of the first electromagnetic wave generation section 36A and the second electrode 42 of the second electromagnetic wave generation section 36B are shared at a position where the first electromagnetic wave generation section 36A and the second electromagnetic wave generation section 36B are arranged side by side in the width direction X. According to this configuration, the first electromagnetic wave generation section 36A and the second electromagnetic wave generation section 36B can be arranged at positions closer to each other. Even in such a case, the first metal plate 51 can suppress interference of an alternating current electric field between the first electromagnetic wave generation section 36A and the second electromagnetic wave generation section 36B. Therefore, it is possible to suppress an increase in the size of the drying device 12.

(7) Even if the plurality of high-frequency voltage generation sections 31 can independently supply high-frequency voltages to the plurality of electromagnetic wave generation sections 36, the first metal plate 51 can suppress interference of an alternating current electric field between the first electromagnetic wave generation section 36A and the second electromagnetic wave generation section 36B. Therefore, it is possible to suppress an increase in the size of the drying device 12.

### MODIFICATIONS

The present embodiment can be implemented with the following modifications. The present embodiment and the following modifications can be implemented in combination with each other within a technically compatible range.

As long as the coil 43A of the first electromagnetic wave generation section 36A and the coil 43A of the second electromagnetic wave generation section 36B are arranged at positions that do not overlap each other in front view, they do not need to be provided on a first intersecting direction Y1 side and a second intersecting direction Y2 side in front view. The coil 43A of the first electromagnetic wave generation section 36A and the coil 43A of the second electromagnetic wave generation section 36B may be arranged at positions where they partially or entirely overlap each other in front view.

The first metal plate 51 and the second electrode 42 may be electrically connected at one end section of both end sections in front view. In such a case, the first metal plate 51 and the second electrode 42 are desirably electrically connected at an end section close to the coil 43A in front view. The first metal plate 51 and the second electrode 42 may be electrically connected to each other on at least one of a first width direction X1 side and a second width direction X2 side.

The second metal plate 52 may be configured to overlap a part of the coil 43A in front view. The drying unit 30 may include one of the first metal plate 51 and the second metal plate 52, and may not include the other.

The second metal plate 52 may be electrically connected to the columnar support 44A instead of the top plate 44B. That is, the second metal plate 52 may be electrically connected to the second conductor 44. The second metal plate 52 may be electrically connected to the second electrode 42 without the second conductor 44 interposed therebetween.

The plurality of high-frequency voltage generation sections 31 are configured to independently supply high-frequency voltages to the plurality of electromagnetic wave generation sections 36, respectively, but may supply high-frequency voltages to the plurality of electromagnetic wave generation sections 36 without being independent of each other. That is, a high-frequency voltage may be supplied from the plurality of high-frequency voltage generation sections 31 to one electromagnetic wave generation section 36. A high-frequency voltage may be supplied from one high-frequency voltage generation section 31 to the plurality of electromagnetic wave generation sections 36. The drying device 12 may include a single high-frequency voltage generation section 31 instead of the plurality of high-frequency voltage generation sections 31.

The plurality of electromagnetic wave generation sections 36 are integrally configured by sharing the second electrode 42, but may not share the second electrode 42. The plurality of electromagnetic wave generation sections 36 may be configured as separate bodies.

The plurality of electromagnetic wave generation sections 36 may be arranged such that the width direction X is a longitudinal direction. That is, the intersecting direction Y may be an example of the second direction. The width direction X may be an example of the third direction. In this manner, the drying unit 30 may be arranged such that the first electrode 41 extends along the width direction X.

The electromagnetic wave generation section 36 may be provided on a back surface 90B side of the medium 90. The electromagnetic wave generation section 36 may be provided on both a front surface 90A side of the medium 90 and a back surface 90B side of the medium 90. The electromagnetic wave generation section 36 may be capable of scanning in the width direction X.

The electromagnetic wave generation section 36 may be provided separately from the facing section 45. That is, the electromagnetic wave generation section 36 may not include the facing section 45. In this case, it is desirable for the facing section 45 to be provided between the first electrode 41 and the second electrode 42, and the medium 90.

The first electrode 41 is not limited to a flat plate shape and may, for example, have a substantially flat plate shape. The substantially flat plate shape may include, for example, a shape curved in a thickness direction, which is a direction along the vertical direction Z, or a linear shape with an extremely large aspect ratio of a rectangular shape.

The second electrode 42 is not limited to a flat plate shape and may, for example, have a substantially flat plate shape. The substantially flat plate shape may include, for example, a shape curved in a thickness direction, which is a direction along the vertical direction Z, or a linear shape with an extremely large aspect ratio of a rectangular shape.

At least one of the first electrode surface 41A and the second electrode surface 42A is not limited to a planar shape and may be a substantially planar shape. The substantially planar shape may include, for example, a shape curved in a thickness direction, which is a direction along the vertical direction Z, or a linear shape with an extremely large aspect ratio of a rectangular shape.

The electromagnetic wave generation section 36 may be provided in the recording device 11 instead of the drying device 12. That is, the recording device 11 may include the electromagnetic wave generation section 36. In this case, the electromagnetic wave generation section 36 may be provided on a downstream side of the recording section 20 in the transport direction D. In this manner, the electromagnetic wave generation section 36 may be applied to the recording device 11 instead of the drying device 12.

A lateral type printer may be adopted as the recording device 11. The lateral type printer is a printer in which the carriage 25 can move in two directions, a main scanning direction and a sub-scanning direction.

The medium 90 is not limited to a roll body. The medium 90 may be a paper sheet, a resin film or sheet, a resin-metal composite film, a laminate film, a textile, a nonwoven fabric, a metal foil, a metal film, a ceramic sheet, a garment, or the like.

Liquid can be arbitrarily selected as long as it can record on the medium 90 by being deposited on the medium 90. For example, ink includes ink in which particles of a functional material made of a solid material such as pigment or a metal particle are dissolved, dispersed, or mixed in a solvent, and includes various compositions such as water-based ink, oil-based ink, gel ink, and hot-melt ink.

As used herein, the phrase "at least any" means one or more of the desired options. As an example, the phrase "at least any" as used herein means only one option if the number of options is two, or both of the two options. As another example, the phrase "at least any" as used herein means only one option or a combination of any two or more options if the number of options is three or more.

### NOTES

Hereinafter, technical ideas grasped from the above-described embodiments and modifications, and operations and effects thereof will be described. The present technical ideas and the operations and effects thereof can be combined with each other within a technically consistent range.

(1) A drying device includes a plurality of electromagnetic wave generation sections that dry a medium, onto which liquid was ejected, by generating an electromagnetic wave in response to application of a high-frequency voltage and a first metal plate, wherein each of the plurality of electromagnetic wave generation sections includes a first electrode, a second electrode arranged so as to surround the first electrode in plan view from a first direction toward the medium, a first conductor that includes a coil and that electrically connects a transmission line, which is configured to transmit a high-frequency voltage, and the first electrode, and a second conductor that electrically connects the transmission line and the second electrode, the plurality of electromagnetic wave generation sections include a first electromagnetic wave generation section and a second electromagnetic wave generation section, the first electromagnetic wave generation section and the second electromagnetic wave generation section are arranged side by side in a second direction that intersects the first direction, and the first metal plate is arranged at a position sandwiching the medium with respect to the plurality of electromagnetic wave generation sections in the first direction and between the first electromagnetic wave generation section and the second electromagnetic wave generation section in the second direction, is configured to extend along the first direction, and is electrically connected to the second electrode of the first electromagnetic wave generation section and to the second electrode of the second electromagnetic wave generation section.

According to this configuration, even when the first electromagnetic wave generation section and the second electromagnetic wave generation section are arranged at positions close to each other, the first metal plate can suppress interference of an alternating current electric field between the first electromagnetic wave generation section and the second electromagnetic wave generation section. Therefore, it is possible to suppress an increase in the size of the drying device.

(2) The above-described drying device may be configured such that the drying device further includes a second metal plate arranged at a position that sandwiches the medium with the first metal plate in the first direction and that is between the first electromagnetic wave generation section and the second electromagnetic wave generation section in the second direction, wherein the second metal plate is configured to extend along the first direction and is electrically connected to the second electrode of the first electromagnetic wave generation section and the second electrode of the second electromagnetic wave generation section.

According to this configuration, even when the first electromagnetic wave generation section and the second electromagnetic wave generation section are arranged at positions close to each other, the second metal plate can suppress interference of an alternating current electric field between the first electromagnetic wave generation section and the second electromagnetic wave generation section. Therefore, it is possible to suppress an increase in the size of the drying device.

(3) The above-described drying device may be configured such that the second metal plate is separated from the second electrode of the first electromagnetic wave generation section and the second electrode of the second electromagnetic wave generation section in the first direction.

According to this configuration, the second metal plate and the second electrode are electrically connected to each other, and the second metal plate and the second electrode are separated from each other. Therefore, by arranging the second metal plate so as to reduce the influence on the first electrode, it is possible to suppress a reduction in energy efficiency of electromagnetic waves generated from the plurality of electromagnetic wave generation sections.

(4) The above-described drying device may be configured such that the coil of the first electromagnetic wave generation section and the coil of the second electromagnetic wave generation section are arranged at positions that do not overlap each other in plan view from the second direction.

According to this configuration, the coil of the first electromagnetic wave generation section and the coil of the second electromagnetic wave generation section can be separated from each other. Accordingly, even when the first electromagnetic wave generation section and the second electromagnetic wave generation section are arranged at positions close to each other, mutual interference between the coil of the first electromagnetic wave generation section and the coil of the second electromagnetic wave generation section can be suppressed. Therefore, it is possible to suppress an increase in the size of the drying device.

(5) The above-described drying device may be configured such that the coil of the first electromagnetic wave generation section is arranged on one side in a third direction intersecting the first direction and the second direction in plan view from the second direction and the coil of the second electromagnetic wave generation section is arranged on an other side in the third direction in plan view from the second direction.

According to this configuration, the same effect as that of (4) can be achieved.

(6) The above-described drying device may be configured such that the first metal plate is electrically connected at both end sections to the second electrode of the first electromagnetic wave generation section and to the second electrode of the second electromagnetic wave generation section in a plan view from the second direction.

According to this configuration, an electric current having a phase opposite to that of an electric current flowing through the second electrode can be generated in a region close to the coil. Therefore, an electric current flowing through the second electrode in the region close to the coil can be reduced. By this, even when the first electromagnetic wave generation section and the second electromagnetic wave generation section are arranged at positions close to each other, the first metal plate can suppress interference of an alternating current electric field between the first electromagnetic wave generation section and the second electromagnetic wave generation section. Therefore, it is possible to suppress an increase in the size of the drying device.

(7) The above-described drying device may be configured such that the second electrode of the first electromagnetic wave generation section and the second electrode of the second electromagnetic wave generation section are shared at a position where the first electromagnetic wave generation section and the second electromagnetic wave generation section are arranged side by side in the second direction.

According to this configuration, the first electromagnetic wave generation section and the second electromagnetic wave generation section can be arranged at positions closer to each other. Even in such a case, the first metal plate can suppress interference of an alternating current electric field between the first electromagnetic wave generation section and the second electromagnetic wave generation section. Therefore, it is possible to suppress an increase in the size of the drying device.

(8) The above-described drying device may be configured such that the drying device further includes a plurality of high-frequency voltage generation sections that generate the high-frequency voltage, wherein the plurality of high-frequency voltage generation sections supply the high-frequency voltage to the plurality of electromagnetic wave generation sections independently of each other.

According to this configuration, even when the plurality of high-frequency voltage generation sections can independently supply high-frequency voltages to the plurality of electromagnetic wave generation sections, interference of alternating current electric fields of the first electromagnetic wave generation section and the second electromagnetic wave generation section can be suppressed by the first metal plate. Therefore, it is possible to suppress an increase in the size of the drying device.

(9) A recording device includes a recording section that performs recording by ejecting liquid onto a medium; a plurality of electromagnetic wave generation sections that dry the medium onto which liquid was ejected by the recording section by generating an electromagnetic wave in response to application of a high-frequency voltage; and a first metal plate, wherein each of the plurality of electromagnetic wave generation sections includes a first electrode, a second electrode arranged so as to surround the first electrode in plan view from a first direction toward the medium, a first conductor that includes a coil and that electrically connects a transmission line, which is configured to transmit a high-frequency voltage, and the first electrode, and a second conductor that electrically connects the transmission line and the second electrode, the plurality of electromagnetic wave generation sections include a first electromagnetic wave generation section and a second electromagnetic wave generation section, the first electromagnetic wave generation section and the second electromagnetic wave generation section are arranged side by side in a second direction that intersects the first direction, and the first metal plate is arranged at a position sandwiching the medium with respect to the plurality of electromagnetic wave generation sections in the first direction and between the first electromagnetic wave generation section and the second electromagnetic wave generation section in the second direction, is configured to extend along the first direction, and is electrically connected to the second electrode of the first electromagnetic wave generation section and to the second electrode of the second electromagnetic wave generation section.

According to this configuration, the same effect as that of (1) can be achieved.

What is claimed is:

1. A drying device comprising:
a plurality of electromagnetic wave generation sections that dry a medium, onto which liquid was ejected, by generating an electromagnetic wave in response to application of a high-frequency voltage and
a first metal plate, wherein
each of the plurality of electromagnetic wave generation sections includes
a first electrode,
a second electrode arranged so as to surround the first electrode in plan view from a first direction toward the medium,
a first conductor that includes a coil and that electrically connects a transmission line, which is configured to transmit a high-frequency voltage, and the first electrode, and
a second conductor that electrically connects the transmission line and the second electrode,
the plurality of electromagnetic wave generation sections include a first electromagnetic wave generation section and a second electromagnetic wave generation section,
the first electromagnetic wave generation section and the second electromagnetic wave generation section are arranged side by side in a second direction that intersects the first direction, and
the first metal plate
is arranged at a position sandwiching the medium with respect to the plurality of electromagnetic wave generation sections in the first direction and between the first electromagnetic wave generation section and the second electromagnetic wave generation section in the second direction,
is configured to extend along the first direction, and
is electrically connected to the second electrode of the first electromagnetic wave generation section and to the second electrode of the second electromagnetic wave generation section.

2. The drying device according to claim 1, further comprising:
a second metal plate arranged at a position that sandwiches the medium with the first metal plate in the first direction and that is between the first electromagnetic wave generation section and the second electromagnetic wave generation section in the second direction, wherein
the second metal plate
is configured to extend along the first direction and
is electrically connected to the second electrode of the first electromagnetic wave generation section and the second electrode of the second electromagnetic wave generation section.

3. The drying device according to claim 2, wherein
the second metal plate is separated from the second electrode of the first electromagnetic wave generation section and the second electrode of the second electromagnetic wave generation section in the first direction.

4. The drying device according to claim 1, wherein
the coil of the first electromagnetic wave generation section and the coil of the second electromagnetic wave generation section are arranged at positions that do not overlap each other in plan view from the second direction.

5. The drying device according to claim 4, wherein
the coil of the first electromagnetic wave generation section is arranged on one side in a third direction intersecting the first direction and the second direction in plan view from the second direction and
the coil of the second electromagnetic wave generation section is arranged on an other side in the third direction in plan view from the second direction.

6. The drying device according to claim 1, wherein
the first metal plate is electrically connected at both end sections to the second electrode of the first electromagnetic wave generation section and to the second electrode of the second electromagnetic wave generation section in a plan view from the second direction.

7. The drying device according to claim 1, wherein
the second electrode of the first electromagnetic wave generation section and the second electrode of the second electromagnetic wave generation section are shared at a position where the first electromagnetic wave generation section and the second electromagnetic wave generation section are arranged side by side in the second direction.

8. The drying device according to claim 1, further comprising:
a plurality of high-frequency voltage generation sections that generate the high-frequency voltage, wherein
the plurality of high-frequency voltage generation sections supply the high-frequency voltage to the plurality of electromagnetic wave generation sections independently of each other.

9. A recording device comprising:
a recording section that performs recording by ejecting liquid onto a medium;
a plurality of electromagnetic wave generation sections that dry the medium onto which liquid was ejected by the recording section by generating an electromagnetic wave in response to application of a high-frequency voltage; and
a first metal plate, wherein
each of the plurality of electromagnetic wave generation sections includes
a first electrode,
a second electrode arranged so as to surround the first electrode in plan view from a first direction toward the medium,
a first conductor that includes a coil and that electrically connects a transmission line, which is configured to transmit a high-frequency voltage, and the first electrode, and
a second conductor that electrically connects the transmission line and the second electrode,
the plurality of electromagnetic wave generation sections include a first electromagnetic wave generation section and a second electromagnetic wave generation section,
the first electromagnetic wave generation section and the second electromagnetic wave generation section are arranged side by side in a second direction that intersects the first direction, and
the first metal plate
is arranged at a position sandwiching the medium with respect to the plurality of electromagnetic wave generation sections in the first direction and between the first electromagnetic wave generation section and the second electromagnetic wave generation section in the second direction,
is configured to extend along the first direction, and
is electrically connected to the second electrode of the first electromagnetic wave generation section and to the second electrode of the second electromagnetic wave generation section.
